(19) United States
(12) Patent Application Publication
(10) Pub. No.: US 2017/0336609 A1
(43) Pub. Date: Nov. 23, 2017

(54) CATADIOPTRIC EYEPIECE SYSTEM, EYEPIECE SYSTEM AND OPTICAL SYSTEM

(71) Applicant: Carl Zeiss AG, Oberkochen (DE)

(72) Inventors: Scott LERNER, Portland, OR (US); Markus SEESSELBERG, Aalen (DE); Tobias BREUNINGER, Herbrechtingen (DE); David SHAFER, Fairfield, CT (US); Toufic JABBOUR, Aalen (DE)

(21) Appl. No.: 15/158,312

(22) Filed: May 18, 2016

(51) Int. Cl. G02B 17/08

(52) U.S. Cl. CPC G02B 17/0884

(57) ABSTRACT

Catadioptric eyepiece system having an exit pupil, comprising a display having a surface disposed in an object plane; optics providing a beam path from the display to the exit pupil and being configured to image a portion of the object plane into an intermediate image formed in a curved intermediate image plane; wherein the optics comprise: a lens system of positive optical power comprising at least one lens, wherein the lens system is disposed in the beam path downstream of the display and upstream of the intermediate image; a concave first mirror disposed in the beam path downstream of the intermediate image and upstream of the exit pupil; and a first beam splitter disposed in the beam path between the lens system and the first mirror and between the first mirror and the exit pupil.

### FIELD

The invention relates to a catadioptric eyepiece system, an eyepiece system having plural catadioptric eyepiece systems and an optical system.

### BACKGROUND

Eyepieces are used in a variety of optical systems such as microscopes, telescopes, head-mounted displays and other optical devices. In microscopy for example, eyepieces are used to form an image on the retina of an observer's eye from a beam path essentially provided by an objective lens. However, in recently developed microscopes, the beam path provided by the objective is not directly directed to the observer's eye via an eyepiece but to a camera system providing image data of an object observed using the microscope. This data is subsequently provided to a digital display of an eyepiece which generates a light image based on the data and, in turn, this image is imaged onto the retina of the observer's eye by the eyepiece. This approach provides several advantages. Such eyepieces are optically decoupled from the remaining microscope optics such as the objective lens by an interposed electric signal processing. Therefore, multiple eyepieces may be provided for multiple observers, each observing an image of the same object. Providing a complex optical system directly optically coupled to the remaining microscope optics may be avoided. Furthermore, the image obtained by the camera may be processed and additional information may be added to the image prior to providing the image to the observer via the eyepiece.

As the quality of the image observed by an observer depends on the quality of the eyepiece, imaging of the image generated by the display of the eyepiece onto the observer's retina must be performed appropriately, i.e. aberrations of the optics used to image the image generated by the display onto the observer's retina should be little and an ametropia of the observer's eye should be taken into account.

### SUMMARY

Therefore, an object of the present invention is to provide an eyepiece system having little aberrations of optics used to image a flat image generated by a substantially flat display onto an observer's retina.

According to an embodiment, a catadioptric eyepiece system having an exit pupil comprises a display having a surface, in particular a flat surface, disposed in an object plane; optics providing a beam path from the display to the exit pupil and being configured to image a portion of the object plane into an intermediate image formed in a curved intermediate image plane. The optics comprise a lens system of positive optical power comprising at least one lens, wherein the lens system is disposed in the beam path downstream of the display and upstream of the intermediate image; a concave first mirror disposed in the beam path downstream of the intermediate image and upstream of the exit pupil; and a first beam splitter disposed in the beam path between the lens system and the first mirror and between the first mirror and the exit pupil.

According to this embodiment, the display is configured to generate an image, for example an image of an object recorded by a camera of an optical microscope. The display may generate the image at the flat surface of the display. In particular, the portion of the object plane imaged into the intermediate image by the optics may comprise the flat surface of the display so that the image generated by the display is imaged into the intermediate image. For this, the flat surface of the display may be disposed in the object plane. The object plane may be an object plane of the lens system with respect to the curved intermediate image plane and the lens system may be configured to image the object plane into the curved intermediate image plane. Herein, a surface may be regarded flat if a radius of curvature of the surface is greater than 0.1 m, in particular 1 m, 5 m, or 10 m.

Furthermore, the optics, in particular the concave first mirror and the first beam splitter, may be configured to form the exit pupil for rays of the beam path emerging from the intermediate image. Consequently, the size of the exit pupil and an eye relief may be decoupled from the size of the display as the exit pupil is formed for rays emerging from the intermediate image.

The exit pupil may be regarded as a substantially flat virtual aperture disposed in an aperture plane located outside of the catadioptric eyepiece system. An observer may observe the image displayed by the display if the observer's eye is positioned at the exit pupil. In particular, if the eye piece comprises an aperture stop, the exit pupil is defined as the image of the aperture stop which is seen from the side of the observer; the center and the diameter of the exit pupil is defined as the center and the diameter of the paraxial image of the aperture stop. In case the eyepiece does not have an aperture stop, the center of the exit pupil may be specified by the intersection points of the principal rays of all pixels of the display. In this case, the principal ray is the axis of the cone of light for which the aberrations are corrected for. Then, the exit pupil diameter EPD can be calculated by EPD=2*NA*f where NA is the numerical aperture of the eyepiece at the display and f is the focal length of the eyepiece.

The eye relief may be regarded as the distance between the exit pupil and a last surface of the catadioptric eyepiece system, in particular the optics, crossed by the beam path. For example, the eye relief may be regarded as a distance between the exit pupil and a surface of a beam splitter element containing the first beam splitter. Herein, the term surface relates to an interface between media having different refractive indices. In particular, the exit pupil may be formed in an aperture plane and the eye relief may be regarded as the distance between the aperture plane and a last surface of the catadioptric eye piece system crossed by the beam path, wherein the distance is measured in a direction along an optical axis of the catadioptric eyepiece system.

According to this embodiment, the catadioptric eyepiece system may have a low-valued Petzval curvature, i.e. the Petzval curvature of the optics may be reduced as follows: the lens system has a positive optical power resulting in a positive Petzval curvature, whereas the concave first mirror provides a negative Petzval curvature despite having a positive optical power. Accordingly, the Petzval curvatures of the lens system and the concave first mirror may compensate for each other, resulting in a low-valued Petzval curvature of the optics and the entire catadioptric eyepiece system. Therefore, the catadioptric eyepiece system according to this embodiment may provide an infinite conjugate image having a low-valued Petzval curvature at the exit pupil.

The portion of the optics upstream of the intermediate image, in particular the lens system, may be configured to generate a predetermined Petzval radius of curvature.

In particular, the predetermined Petzval radius of curvature may be greater than two times a focal length of the eyepiece system, in particular greater than five times the focal length of the eyepiece system, more in particular greater than ten times the focal length of the eyepiece system. In particular, the predetermined Petzval radius of curvature may be less than 100 times a focal length of the eyepiece system, in particular less than 50 times the focal length of the eyepiece system, more in particular less than 20 times the focal length of the eyepiece system. Therefore, compensating and reducing of the Petzval curvature of the eyepiece system may be improved.

Furthermore, the optics, in particular the at least one lens of the lens system, the concave first mirror and the first beam splitter may provide plural degrees of freedom which may be used to reduce other aberrations of the optics such as spherical aberration, coma, astigmatism, etc. Also, the first mirror may be concentric to a center of the exit pupil. Therefore, no coma or astigmatism is introduced by the first mirror.

According to this embodiment, in the beam path from the display to the exit pupil, the lens system is disposed downstream of the display and upstream of the intermediate image. Therefore, the lens system may be configured to generate the intermediate image. Furthermore, the optics, in particular the lens system, may be configured to form an intermediate pupil in the beam path upstream of the intermediate image. Herein, the optics, and in particular the lens system, may be configured to form the intermediate pupil within or outside of the at least one lens of the lens system. Alternatively, the optics, and in particular the lens system, may be configured to form the intermediate pupil within the lens system.

The catadioptric eyepiece system may be configured to allow for a diopter compensation, i.e. the catadioptric eyepiece system may be adaptable during operation in order to compensate for the ametropia of an observer's eye. This diopter compensation may be provided by displaceable components of the optics or by a displaceable display. According to an exemplary embodiment, at least one of the display and the at least one lens of the lens system are displaceable relative to each other along an optical axis for diopter compensation. According to this embodiment, the display and/or the at least one lens may be displaceable relative to the other. The diopter compensation may also be provided by configuring the portion of the optics upstream of the intermediate image displaceable relative to the portion of the optics downstream of the intermediate image.

According to an exemplary embodiment, a focal plane of the first mirror coincides with the curved intermediate image plane if the optics are set for an emmetropic eye. Therefore, the first mirror images the intermediate image to infinite conjugate at the exit pupil if the optics are set for an emmetropic eye. Herein, a location of the focal plane of the first mirror may be influenced by optical properties of a first beam splitter element containing the first beam splitter disposed in the beam path between the first mirror and the intermediate image plane. Accordingly, the first mirror and the first beam splitter, and in particular the first beam splitter element, may be configured so that the resulting focal plane of the first mirror coincides with the curved intermediate image plane if the optics are set for an emmetropic eye.

According to an exemplary embodiment, the curved intermediate image plane has a radius of curvature less than 200 mm, in particular less than 80 mm, more in particular less than 20 mm. Furthermore, the curved intermediate image plane may have a radius of curvature being greater than 5 mm, in particular greater than 50 mm, more in particular greater than 15 mm. According to this embodiment, the intermediate image is substantially curved as it is formed in a substantially curved intermediate image plane. The curvature of the intermediate image plane may in particular correspond to the Petzval curvature of the portion of the optics upstream of the intermediate image, in particular the Petzval curvature of the lens system.

According to an exemplary embodiment, the intermediate image is a real image.

According to an exemplary embodiment, the first mirror has a radius of curvature of less than 180 mm, in particular less than 90 mm and more in particular less than 50 mm. Furthermore, the first mirror may have a radius of curvature being greater than 10 mm, 15 mm or 20 mm. In particular, the first mirror may have a surface receiving rays of the beam path emerging from the intermediate image and directing said rays in direction of the exit pupil. This surface may be concave with respect to the exit pupil The first mirror may be concentric to the exit pupil, in particular concentric to a center of the exit pupil and/or an optical axis of the eyepiece system. A concentric mirror may reduce aberrations at the exit pupil. The size of the first mirror may be selected based on a typical value of the interpupilar distance.

According to an exemplary embodiment, at least a portion of the intermediate image is formed within a first beam splitter element containing the first beam splitter. According to this embodiment, the first beam splitter is contained in the first beam splitter element such as a glass cube, a prism, a glass plate, a pellicle, etc. The first beam splitter element may be disposed so that the first beam splitter is in close proximity to the intermediate image and, therefore, at least a portion of the intermediate image may be formed within the first beam splitter element.

According to an exemplary embodiment, the first mirror and the first beam splitter, and in particular a first beam splitter element containing the first beam splitter, are configured to generate an eye relief being greater than 10 mm, in particular greater than 20 mm, more in particular greater than 30 mm and/or being less than 150 mm, in particular less than 100 mm. As mentioned above, the distance between the exit pupil and a last surface of the optics, in particular a last surface of the first beam splitter element, crossed by the beam path may be referred to as the eye relief. For an observer's convenience, a sufficiently large eye relief is preferable. In particular, optical properties of the first mirror and the first beam splitter may be selected so that a convenient eye relief is achieved.

Another aspect of eyepiece systems is to provide a large field of view at the exit pupil. The field of view depends on the size of the display to be imaged to the exit pupil and the focal length of the optics constituting the eyepiece system. Often, the diagonal field of view is specified which is the angle of light emitted from the corner of the display at the exit pupil with respect to an optical axis of the eyepiece. Let f denote the focal length of the eyepiece and let h denote the distance of a corner of the rectangular display to the center of the display. Then, the field of view FOV is defined according to FOV=arctan(h/f). In a similar way a horizontal FOV and a vertical FOV could be calculated by arctan(x/f) and arctan(y/f) where y and x are the half edge length of the display. The catadioptric eyepiece system, in particular its components such as the first mirror and the first beam splitter, may be configured so that a horizontal field of view and a vertical field of view may amount to values of at least 20° and 15°, respectively. In particular, the optical properties of the first mirror and the first beam splitter, such as a radius of curvature of the first mirror, a refractive index of a first beam splitter element containing the first beam splitter, the shape of the first beam splitter element etc., may be selected appropriately.

According to an exemplary embodiment, the first mirror is one of a front surface mirror, a back surface mirror and a mirror sharing a common surface with a first beam splitter element containing the first beam splitter, wherein the common surface is disposed in the beam path. A front surface mirror comprises a highly reflective surface essentially defining the optical properties of the front surface mirror. Light incident onto the front surface mirror is only reflected by the reflective surface and is not refracted by other components of the front surface mirror. In contrast to a front surface mirror, a back surface mirror comprises a highly reflective surface and a refractive element. Light incident onto the back surface mirror is refracted by the refracting element and reflected at the reflective surface to be again refracted by the refracting element. In addition or alternatively to the front surface mirror and the back surface mirror, the first mirror may comprise a highly reflective surface contacting a curved surface of the first beam splitter element containing the first beam splitter. For this, the curvature of the curved surface may correspond to the curvature of the first mirror. Accordingly, the first mirror is in contact with the first beam splitter element at the curved surface of the first beam splitter element. Therefore, Fresnel reflection at an additional interface otherwise present can be avoided which helps to reduce stray light which may originate at the refractive surface of a back surface mirror.

According to an exemplary embodiment, the first beam splitter is configured to direct rays of the beam path emerging from the intermediate image to the first mirror and to direct rays emerging from the first mirror to the exit pupil. In particular, the first beam splitter may be configured to transmit rays of the beam path emerging from the intermediate image and to reflect rays emerging from the first mirror. Alternatively, the first beam splitter may be configured to reflect rays of the beam path emerging from the intermediate image and to transmit rays of the beam path emerging from the first mirror. In particular, the first beam splitter may be an amplitude beam splitter or a polarizing beam splitter.

According to an exemplary embodiment, the lens system and the first mirror are configured to compensate for each other's Petzval curvature. In particular, the lens system having a positive optical power, thus having a positive Petzval curvature, and the first mirror having a positive optical power, thus having a negative Petzval curvature, may be configured so that the Petzval curvatures of the lens system and the first mirror cancel each other at least partially. In particular, the optical properties of the lens system and the first mirror may be selected so that the Petzval curvatures of the lens system and the first mirror cancel each other at least partially.

According to an exemplary embodiment herein, the lens system and the first mirror are configured, in particular the optical properties of the lens system and the first mirror are selected, so that an absolute value of a Petzval radius of curvature of the optics is greater than 150 mm, in particular greater than 200 mm, more in particular greater than 250 mm. According to this embodiment, the Petzval curvature of the optics is effectively compensated, i. e. the Petzval curvature of the optics essentially cancels, resulting in a high quality imaging of the optics.

According to an exemplary embodiment, the optics further comprise a second mirror disposed in the beam path downstream of the lens system and upstream of the intermediate image. The second mirror may be one of a front surface mirror, a back surface mirror and a mirror sharing a common surface with a second beam splitter element containing a second beam splitter, wherein the common surface is disposed in the beam path. According to this embodiment, the portion of the optics upstream of the intermediate image is a catadioptric system itself. The second mirror and the second beam splitter, and in particular the second beam splitter element, may be configured to provide additional degrees of freedom which may be used to compensate for aberrations, in particular aberrations other than the Petzval curvature. The second beam splitter may be disposed in the beam path between the lens system and the second mirror, i.e. the second beam splitter may be configured to transmit rays of the beam path emerging from the lens system to the second mirror and to reflect rays emerging from the second mirror to the first beam splitter.

Alternatively, the second beam splitter may be configured to reflect rays emerging from the lens system to the second mirror and to transmit rays emerging from the second mirror to the first beam splitter.

According to an exemplary embodiment, the optics, in particular the portion of the optics upstream of the intermediate image, are further configured to form an intermediate pupil in the beam path upstream of the intermediate image. The intermediate pupil may be disposed within the lens system, in particular within the at least one lens of the lens system. Furthermore, the at least one lens may comprise at least one of a cemented lens element, a lens having an aspheric surface, a diffractive optical element (DOE) and a meniscus lens. In particular, a center of curvature of at least one surface of the meniscus lens may coincide with a center of the intermediate pupil, wherein the center of curvature of a surface may be regarded as a center of a sphere having a curvature approaching the curvature of the surface. The optical properties of the at least one lens may be selected so that aberrations, in particular aberrations other than the Petzval curvature, such as spherical aberration, coma etc. may be reduced effectively. In particular, the cemented lens element, the lens having an aspheric surface and the meniscus lens may provide degrees of freedom to reduce aberrations without introducing coma or astigmatism.

According to an exemplary embodiment, the catadioptric eyepiece system further comprises a light source configured to emit illumination light; a third beam splitter disposed in a beam path between the light source and the display, wherein the third beam splitter is configured to direct the illumination light onto the flat surface and to direct light reflected by the display into the beam path of the optics; wherein the display is a reflective display, in particular a liquid crystal on silicon display.

According to this embodiment, a light source is used to illuminate a reflective display, such as a liquid crystal on silicon (LCoS) display, so that a bright image may be generated on the flat surface of the display. The third beam splitter which may be contained in a third beam splitter element is disposed in the beam path between the light source and the display so that illumination light may be incident onto the display and light deflected at the display may be directed into the beam path of the optics.

According to an exemplary embodiment herein, a working distance between the object plane and a first surface of the optics is greater than 30 mm, in particular greater than 35 mm, more in particular greater than 40 mm. According to this embodiment, the working distance of the lens system, in particular of the portion of the optics upstream of the intermediate image, are selected so that the third beam splitter, in particular the third beam splitter element, may be disposed in the beam path between the first surface of the optics and the object plane. Here, the object plane is located outside of the third beam splitter element so that the display can be disposed in the object plane. The first surface of the optics may be regarded as a first surface, i. e. an interface between media having different refractive indices, crossed by the beam path. In particular, the first surface of the optics may be the first surface of the lens system crossed by the beam path.

According to an exemplary embodiment, the display is a light emitting display. Accordingly, a light source and a third beam splitter may not be necessary. Alternatively, the display may be a light transmitting display illuminated from a side of the display opposite to the side of the display facing the optics such as a transmissive LCD display. Alternatively, the display may comprise organic light emitting diodes (OLED), a micro display or other types of light emitting displays.

According to an exemplary embodiment, an aperture of the exit pupil has a diameter greater than 5 mm, in particular greater than 9 mm, more in particular greater than 14 mm. According to this embodiment, the first mirror and the first beam splitter are configured to generate the aperture of the exit pupil accordingly, for example by selecting the optical properties of the first mirror and the first beam splitter appropriately.

According to an exemplary embodiment, the catadioptric eyepiece system further comprises an aperture stop disposed in the beam path between the first beam splitter and the object plane, in particular at the intermediate pupil. According to this embodiment, light emerging from the display outside of the cone of light defined by the numerical aperture and the chief ray and being incident onto the aperture stop may be absorbed in order to avoid directing this light to an observer's eye. Such light may suffer from insufficient aberration correction propagating through the catadioptric eyepiece system.

As described above, a size of the display, in particular a size of the flat surface, is decoupled from a size of the exit pupil, in particular a size of an aperture of the exit pupil, due to the formation of the intermediate image and its subsequent imaging to infinite conjugate at the exit pupil if the optics are set for an emmetropic eye. Therefore, the size of the display in a direction of the object plane may be selected to be small, i. e. less than 50 mm, in particular less than 30 mm, more in particular less than 20 mm. Furthermore, the size of the display in a direction of the object plane may be selected to be larger than 10 mm, in particular larger than 15 mm or larger than 20 mm.

Each of the first, second and third beam splitter elements may comprise light absorbing coatings and the like in order to absorb light directed into undesired directions.

According to an exemplary embodiment, the catadioptric eyepiece system further comprises a polarizer disposed upstream of the first beam splitter and a waveplate disposed between the first beam splitter and the first mirror and wherein transmission and reflection of the first beam splitter are polarization dependent. The polarizer may be disposed between the first beam splitter and the lens system, for example. Alternatively, the polarizer may be disposed within or upstream of the lens system.

In the catadioptric eyepiece system, light emerging from the display is reflected once at and transmitted once through the first beam splitter before arriving at the exit pupil. If, for example, the first beam splitter has a reflection and transmission of 50%, respectively, only 25% of the light emerging from the display can be provided at the exit pupil. In order to enhance the amount of light passing the catadioptric eyepiece and to minimize the losses due to the first beam splitter, the catadioptric eyepiece comprises a polarizer disposed upstream of the first beam splitter, a waveplate disposed between the first beam splitter and the first mirror and the transmission and reflection of the first beam splitter are polarization dependent.

In an exemplary embodiment, the polarizer generates light linearly polarized in a first direction. The first beam splitter may be configured so that almost 100% of the polarized light may be directed, i. e. transmitted or reflected, to the first mirror. For example, the beam splitter may be provided as a MacNeille cube or as a wire grid beamsplitter which are commercially available from Moxtek Inc. 452 W 1260 N, Orem, Utah 84057 USA. The waveplate, which may be an integral part of the first mirror, may be a quarter-wave plate configured to convert the linearly polarized light received from the first beam splitter into circularly polarized light. Upon reflection at the first mirror, the handiness of the circularly polarized light is inverted. The light reflected by the first mirror is converted to light linearly polarized in a second direction by the quarter-wave plate. However, the first and second directions and, hence the respective light polarizations, are orthogonal to each other. Therefore, almost 100% of the light linearly polarized in the second direction may pass the first beam splitter, i. e. be reflected or transmitted, respectively. As a consequence, almost 50% of the light emerging from the display can be provided at the exit pupil.

According to an exemplary embodiment, the first beam splitter is configured to direct infrared light emitted by an analysis apparatus for analyzing an observer's eye to the exit pupil. In particular, the first beam splitter may be configured to reflect or transmit at least 80%, in particular at least 90% or at least 99%, of infrared light incident onto the first beam splitter.

The eyepiece system may comprise analysis apparatus for analyzing an observer's eye wherein the analysis apparatus is disposed opposite to the lens system or the first mirror with respect to the first beam splitter. These apparatuses may comprise a gaze tracker suitable to measure the line of sight of observer's eye or a refractometer suitable to measure the accommodation of observer's eye. Such analysis apparatuses are disclosed in US 2013/0076960 A1, for example, the contents of which are incorporated herein by reference.

According to an alternative embodiment, a catadioptric eyepiece system comprises a display having a flat surface disposed in an object plane; optics providing a beam path from the display to an exit pupil; and an analysis apparatus for analyzing a patient's eye; wherein the optics comprise: a lens system of positive optical power comprising at least one lens, wherein the lens system is disposed in the beam path downstream of the display and upstream of a first beam splitter; a concave first mirror disposed in the beam path downstream of the first beam splitter; and wherein the first beam splitter is configured to direct infrared light emitted by the analysis apparatus to the exit pupil.

For details concerning the individual components of the catadioptric eyepiece system, reference is made to the description of said components herein.

According to an embodiment, an eyepiece system comprises at least two of the above described catadioptric eyepiece systems, wherein the first beam splitters of the at least two catadioptric eyepiece systems are portions of a single beam splitter.

According to this embodiment, eyepiece systems for the two eyes of an observer or for multiple observers may be provided using a single beam splitter functioning as the first beam splitters of the individual catadioptric eyepiece systems. When arranging two individual catadioptric eyepiece systems side by side, for example for the two eyes of an observer, and each of the catadioptric eyepiece systems has its own individual first beam splitter, the size of the first beam splitters may be limited by an available construction space. Accordingly, the optical properties of these first beam splitters may be limited due to limited the available construction space. According to this embodiment, a single beam splitter is used as the first beam splitters of the at least two catadioptric eyepiece systems so that the single beam splitter may be larger than each of the individual first beam splitters of the individual catadioptric eyepiece systems. Therefore, the degrees of freedom of the single beam splitter may be limited less by the available constructions base.

According to an exemplary embodiment herein, the lens system, the first mirror and the exit pupil of the at least two catadioptric eyepiece systems are displaceable relative to each other in a direction parallel to a long side of the single beam splitter. According to this embodiment, the single beam splitter has a long side, i. e. a predominant size in one direction compared to the other sides. The lens system, in particular the portion of the optics upstream of the intermediate image, the first mirror and the exit pupil of the at least two catadioptric eyepiece systems may be displaceable in a direction of the long side in order to adapt the eyepiece system to an observer's interpupilar distance.

According to an exemplary embodiment, the first mirrors of the at least two catadioptric eyepiece systems are located on different sides of the single beam splitter. According to this embodiment, the first mirror of a catadioptric eyepiece system and the first mirror of another catadioptric eyepiece are located on different sides of the single beam splitter providing the first beam splitters of said catadioptric eyepiece systems. As the first mirrors are located on different sides of the single beam splitter, the first mirrors do not obstruct each other when disposed close to each other. For example, when a small interpupilar distance for the observer's eyes must be provided, the first mirrors must be disposed close to each other. In order to avoid collision of the first mirrors, said first mirrors are provided on different sides of the single beam splitter.

According to an embodiment, an optical system having an eyepiece system according to the above description, i. e. an eyepiece system or a catadioptric eyepiece system, comprises at least one of an optical microscope, a surgical microscope, a viewfinder, a charged particle beam microscope, a head-mounted display and the like.

### BRIEF DESCRIPTION OF THE DRAWINGS

The forgoing as well as other advantageous features of the disclosure will be more apparent from the following detailed description of exemplary embodiments with reference to the accompanying drawings. It is noted that not all possible embodiments necessarily exhibit each and every, or any, of the advantages identified herein.

FIG. 1 shows a schematic illustration of an exemplary embodiment of a catadioptric eyepiece system;

FIG. 2 shows a schematic illustration of another exemplary embodiment of a catadioptric eyepiece system;

FIG. 3 shows a schematic illustration of another exemplary embodiment of a catadioptric eyepiece system;

FIG. 4 shows a schematic illustration of another exemplary embodiment of a catadioptric eyepiece system;

FIG. 5 shows a schematic illustration of another exemplary embodiment of a catadioptric eyepiece system; and

FIG. 6 shows a schematic illustration of an embodiment of an eyepiece system.

### DETAILED DESCRIPTION OF EXEMPLARY EMBODIMENTS

In the exemplary embodiments described below, components that are alike in function and structure are designated as far as possible by alike reference numerals. Therefore, to understand the features of the individual components of a specific embodiment, the descriptions of other embodiments and of the summary of the disclosure should be referred to.

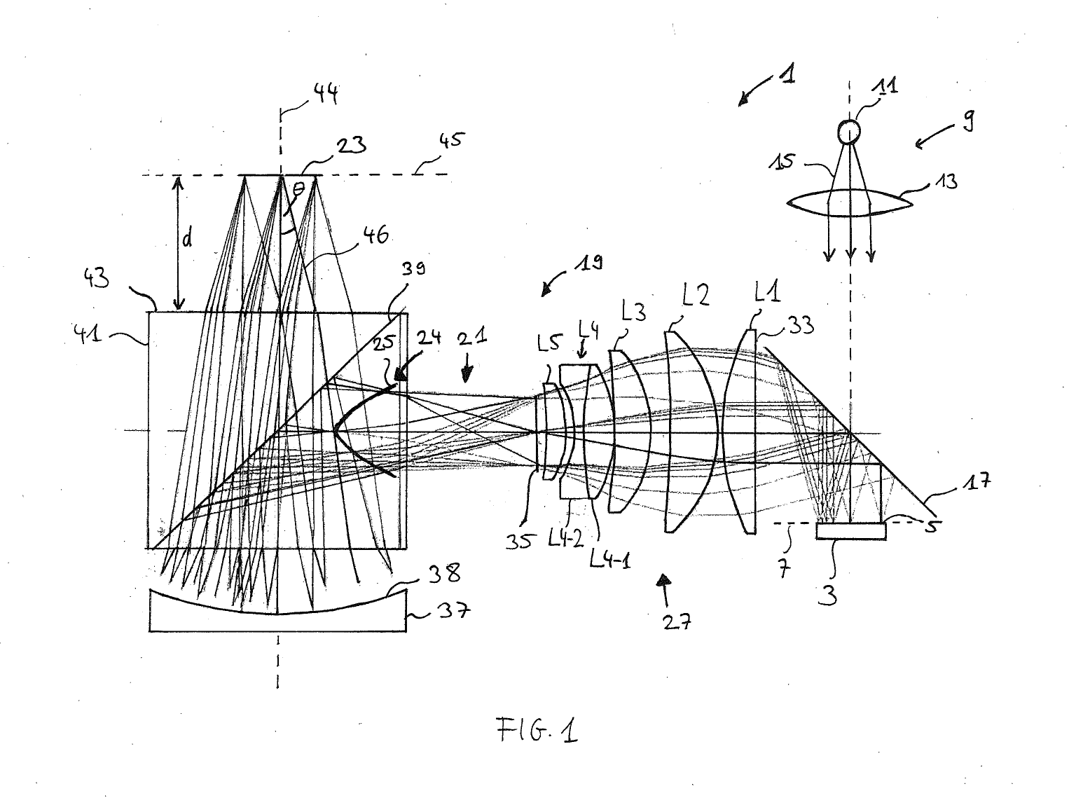

FIG. 1 shows an embodiment of a catadioptric eyepiece system 1. The catadioptric eyepiece system 1 comprises a display 3 having a flat surface 5. The display 3 is configured to generate the light image on the flat surface 5. The display 3, in particular the flat surface 5, is disposed in an object plane 7. In case of the embodiment shown in FIG. 1, the display 3 is a reflective display such as a liquid crystal on silicone display which, together with an illumination system 9, may generate bright images as compared to light emitting displays. The illumination system 9 comprises a light source 11 and a condenser lens 13 configured to direct illumination light 15 towards the display 3, in particular onto the flat surface 5. A third beam splitter 17 is disposed in a beam path between the illumination system 9, in particular the light source 11, and the display 3. The third beam splitter 17 is configured to direct the illumination light 15 onto the flat surface 5 of the display 3. In particular, according to the embodiment illustrated in FIG. 1, the third beam splitter 17 is configured to transmit the illumination light 15 to the flat surface 5.

The catadioptric eyepiece system 1 further comprises optics 19 providing a beam path 21 from the display 3 to an exit pupil 23 of the catadioptric eyepiece system 1. An infinite conjugate image of the image generated by the display 3 is formed by the optics 19. The exit pupil 23 disposed in an aperture plane 45 is given by the image of an aperture stop that may be disposed at an intermediate pupil 35, seen from the observer's side.

The optics 19 are configured to image a portion of the object plane 7 into an intermediate image 24 formed in a curved intermediate image plane 25. For this, the optics 19 comprise a lens system 27, wherein the lens system 27 provides a positive refractive power. In the embodiment illustrated in FIG. 1, the lens system 27 comprises five lenses L1, L2, L3, L4 and L5. The lens L4 is a doublet such as cemented lens element comprising lens elements L4-1 and L4-2. The lens system 27 may comprise spherical lenses, aspheric lenses, i.e. lenses having an aspheric surface, and/or a lens with a diffractive optical surface. The individual lenses L1, L2, L3, L4 and L5 may be selected as to reduce aberrations such as spherical aberration, astigmatism, etc. as well as color aberrations of the catadioptric eyepiece system.

The lens system 27 may be configured to provide a sufficiently large working distance in order to allow disposing the third beam splitter 17 in the beam path between the object plane 7 and a first surface 33 of the optics. The first surface is a surface, i.e. an optical interface between media having different refractive indices, which is first crossed by the beam path 21. Alternatively, the first surface may be regarded as a surface of the lens system 27 first crossed by the beam path 21. The optics 19, in particular the lens system 27, is configured to form an intermediate pupil 35 in the beam path 21 upstream of the intermediate image 24. The optics 19, in particular the lens system 27, is configured to image an aperture stop disposed at the intermediate pupil 35 to infinity when seen from the display's side. Thus, the system is telecentric, i. e. the principal rays at the display are parallel to the optical axis. Light rays emerging from the object plane 7 in a same direction, i.e. parallel rays emerging from the object plane 7, cross the intermediate pupil 35 at a same location but at different angles relative to the intermediate pupil 35. Furthermore, rays emerging from the object plane 7 into different directions but from a same point on the object plane 7 cross the intermediate pupil 35 at different locations within the intermediate pupil 35. In the embodiment illustrated in FIG. 1, the intermediate pupil 35 is located outside of the lens system 27 and, in particular, outside of one of the lenses L1, L2, L3, L4 and L5 of the lens system 27.

Note that a portion of the intermediate image 24 is formed within the first beam splitter element 41.

The optics 19 further comprise a concave first mirror 37 which is a front surface mirror and a first beam splitter 39. The first mirror 37 is disposed in the beam path 21 downstream of the intermediate image 24 and upstream of the exit pupil 23. In particular, the first mirror 37 may be a spherical mirror. Note that some of the rays illustrated in FIG. 1 run above and below the paper plane of FIG. 1. These rays are projected onto the paper plane, which is the reason why not all of the illustrated rays are drawn up to a surface 38 of the mirror 37.

The first beam splitter 39 is disposed in the beam path 21 disposed in the beam path 21 between the lens system 27 and the first mirror 37 and between the first mirror 37 and the exit pupil 23. In particular, the beam splitter 39 is disposed in the beam path 21 between the intermediate image 24 and the first mirror 37.

The optics may comprise displaceable elements, for example the display 3. This embodiment is well suited for compensation of ametropia of the observer by moving display 3 along the optical axis for the following reason. Since the eyepiece is telecentric at display's side, the principal rays are parallel to the optical axis. Therefore, by shifting the display 3 along an optical axis ametropia of observer's eye can be corrected for whereas the magnification does not change. Especially when two eyepieces are used for two eyes of the observer, a constant magnification ensures that both images appear under the same magnification which mitigates unwanted effects such as binocular rivalry. Alternatively, also the lenses L1 and/or L2 and/or L3 and/or L4 and/or L5 of the lens system 27 and/or the display 3 may be displaceable relative to each other in order to allow for a diopter compensation, i.e. a compensation for an ametropia of an observer's eye. When the optics 19, in particular the display 3 and the lens system 27, are set for an emmetropic eye, the first mirror 37 and the beam splitter 39 as well as a first beam splitter element 41 containing the first beam splitter 39 are configured to generate an infinite conjugate image of the intermediate image 24 which can be observed by an observer's eye when the pupil of the eye intersects the exit pupil 23.

As the lens system 27 provides a positive optical power, the lens system 27 has a positive Petzval curvature. Similarly, the concave first mirror 37 provides a positive optical power, however this results in a negative Petzval curvature. Therefore, by appropriately selecting the optical properties of the lens system 27 and the concave first mirror 37, the Petzval curvatures may compensate each other so that an essentially vanishing Petzval curvature is achieved for the beam path 21.

As described above, the catadioptric eyepiece system 1 provides a diopter compensation by providing displaceable components of the optics 19. FIG. 1 shows the catadioptric eyepiece system 1 wherein the optics 19 are set for an emmetropic eye. Therefore, a focal plane of the first mirror 37 coincides with the curved intermediate image plane 25 so that the first mirror 37 generates an infinite conjugate image of the intermediate image 24 which can be observed by an observer's eye intersecting the exit pupil 23.

The first mirror 37 and the first beam splitter 39, and in particular the first beam splitter element 41, are configured to generate a convenient eye relief. The eye relief is the distance between the exit pupil 23 and a last surface 43 of the optics 19 crossed by the beam path 21. In particular, the eye relief is the distance between the exit pupil 23 and the last surface 43 of the first beam splitter element 41 crossed by the beam path 21. The eye relief is indicated by a distance d and convenient values of the eye relief may amount to values greater than 12 mm.

Another aspect of the catadioptric eyepiece system 1 is the available field of view FOV. The field of view may be represented by an angle of view θ between the optical axis 44 and an oblique ray 46 transmitted through the eyepiece system 1. By appropriately selecting the focal length of the optics 19 and the size of the display 3, the angle θ may amount to a value of at least 20° in a horizontal plane and at least 15° in a vertical plane.

Detailed information on parameters of lenses and mirrors, such as the type and optical power of the lenses and the radius of curvature of the mirror are listed in Table 1.

TABLE 1

| # | Type | |
|---|---|---|
| | | Optical Power (diopter) |
| L1 | Glas Sumita KGFK68 | +12.700 |
| L2 | Glas Ohara SFPL53 | +13.690 |
| L3 | Glas Schott NBK7 | +15.362 |
| L4-1 | Glas Ohara SFPL53 | +11.697 |
| L4-2 | Glas Schott NKZFS8 | −29.558 |
| L5 | Gas Schott NBK7 | +24.811 |
| | | Radius of Curvature (mm) |
| 41 | Schott SF10 | — |
| 37 | — | 67 |

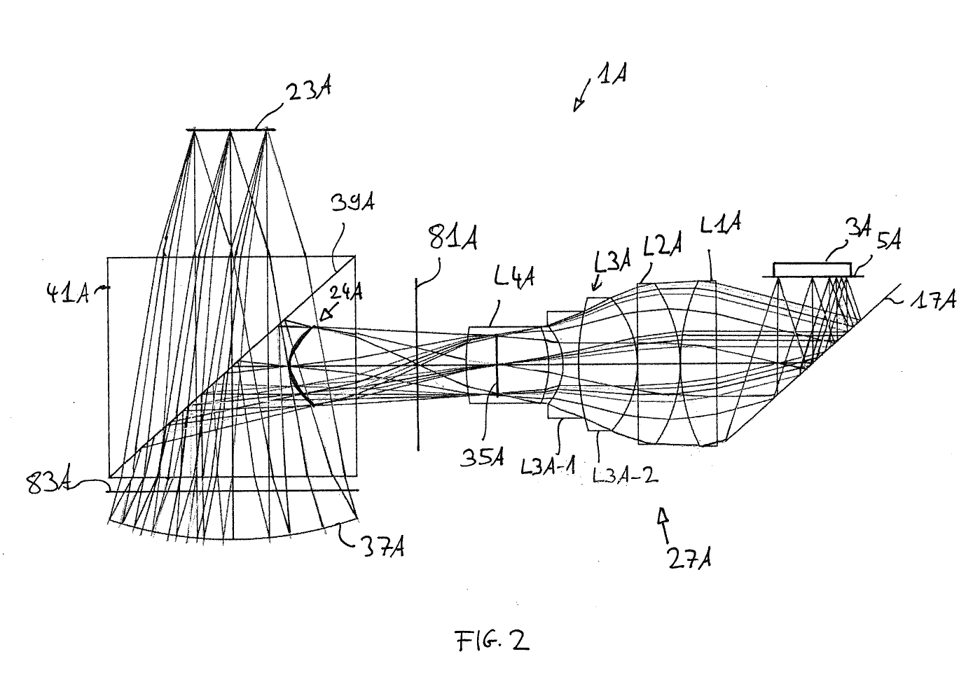

FIG. 2 shows a schematic illustration of another exemplary embodiment of a catadioptric eyepiece system 1A which is similar to the system 1 illustrated in FIG. 1. In contrast to the system 1 illustrated in FIG. 1, the lens system 27A of the catadioptric eyepiece system 1A illustrated in FIG. 2 comprises four lenses L1A, L2A, L3A and L4A, wherein L3A is a doublet of the lens elements L3A-1 and L3A-2.

In contrast to the system 1 of FIG. 1, the display 3A is configured to emit light actively. As an example, the display 3A could be a transmissive LCD display which is illuminated from the back side by parallel bundles of light which enclose a certain maximum angle with the normal to the flat surface 5A. As a consequence, each pixel of the display emits a cone of light with a given numerical aperture NA and with an axis being perpendicular to the flat surface 5A of the display 3A Thus, the principal rays which are similar to the axes of the light cones perpendicular to the flat surface 5A. The system 1A illustrated in FIG. 2 also forms an intermediate pupil 35A where the principal rays converge. However the intermediate pupil 35A is not accessible as it is located within the lens L4A.

Detailed information on parameters of the lenses are listed in Table 2 wherein the radii and center-thicknesses are given in units of mm. “DIST” denotes a distance in mm between respective lenses. Surfaces of the lenses are enumerated in the order the beam path passes them from the display 3A to the exit pupil 23A.

The distance between the first beam splitter element 41A and L4A amounts to 21 mm.

The edge length of the first beam splitter element 41A amounts to 48 mm and it consists of SF10. The first mirror 37A is disposed at a distance of 13 mm from the first beam splitter element 41A.

TABLE 2

| | | | | | Center- |
|---|---|---|---|---|---|
| | | Optical Power | | Radius | Thickness |
| # | Type | (diopter) | Surface | [mm] | [mm] |
| L1A | NLASF41 | 17.7 | 1 | ∞ | 7 |
| | | | 2 | 47.438 | |
| | | | DIST | | 0.1 |
| L2A | SPHM52 | 18.0 | 3 | 34.479 | 8.2 |
| | | | 4 | ∞ | |
| | | | DIST | | 0.1 |
| L3A-1 | NSK5 | 22.1 | 5 | 23.447 | 11.4 |
| | | | 6 | 58.504 | |
| L3A-2 | NSF6 | −39.5 | 7 | 58.504 | 3 |
| | | | 8 | 13.914 | |
| | | | DIST | | 2.8 |
| L4A | STIM5 | 34.0 | 9 | 23.673 | 16 |
| | | | 10 | 54.596 | |

In contrast to the embodiment illustrated in FIG. 1, the catadioptric eyepiece system 1A further comprises a polarizer 81A and a waveplate 83A and the reflection and transmission of the first beam splitter element 41A are polarization dependent. In particular, the polarizer 81A is disposed between the first beam splitter element 41A and the lens system 27A and is configured to transmit light polarized in a first direction only. However, the polarizer may be included in the third beam splitter 17A, for example. The waveplate is a quarter-wave plate disposed between the first beam splitter element 41A and the first mirror 37A and is configured to convert linearly polarized light into circularly polarized light and vice versa. The first beam splitter element 41A is a MacNeille beam splitting cube or a wire grid beamsplitter.

For example, the first beam splitter 39A provided by the first beam splitter element 41A may configured to reflect almost 100% of light polarized in the first direction and to transmit almost 100% of light polarized in a second direction orthogonal to the first direction.

As a consequence, light entering the first beam splitter element 41A from the polarizer 81A is linearly polarized in the first direction and almost 100% of this light is reflected at the first beam splitter 39A towards the first mirror 37A. Subsequently, the light linearly polarized in the first direction is converted into circularly polarized light by the waveplate 83A. Upon reflection at the first mirror 37A, the handiness of the circularly polarized light is inverted. Subsequently, the circularly polarized light having the inverted handiness is converted into light linearly polarized in the second direction by the waveplate 83A. As the first direction is orthogonal to the second direction, the first beam splitter element can transmit almost 100% of the light being linearly in the second direction coming from the first mirror 37A.

As a consequence, downstream of the polarizer 81A, nearly no light is reflected into the upstream direction which, in turn, reduces stray light and enhances the contrast at the exit pupil.

Assuming that unpolarized light is incident onto the polarizer 81A, about 50% of the unpolarized light is lost for the imaging due to the polarizer 81A. However, as nearly no light is lost downstream of the polarizer 81A, a total of 50% of the light incident onto the polarizer 81A can be received at the exit pupil. In contrast to that, without providing the polarizer, waveplate and polarization dependent properties of the first beam splitter and assuming a 50/50-beam splitter as the first beam splitter, only 25% of the light entering the first beam splitter element from the lens system can be provided at the exit pupil.

In case a transmissive LCD display is used in combination with FIG. 2, the polarizer 81A could be omitted since the light transmitted by the LCD display in the direction of the eyepiece optics is already linearly polarized.

In case an LCoS display is used in combination with FIG. 2, the third beamsplitter 17A may be a polarization beam splitter. In this case, the polarizer 81A could be omitted since the light reflected at the beamsplitter 17A is already linearly polarized.

Although only the embodiment illustrated in FIG. 2 is equipped with the polarizer, waveplate and polarization dependent first beam splitter in the description, the concept may be employed in the other embodiments described herein without additional effort.

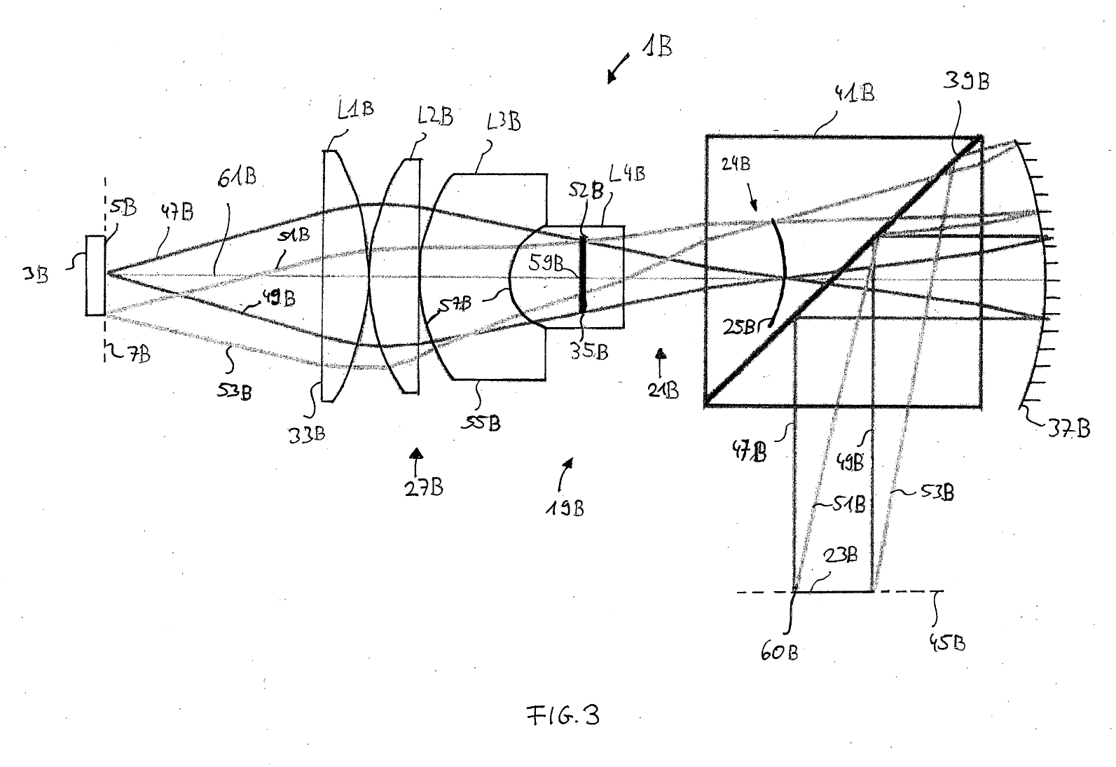

FIG. 3 shows a schematic illustration of another exemplary embodiment of a catadioptric eyepiece system 1B. Similarly to the embodiment illustrated in FIG. 1, the catadioptric eyepiece system 1B illustrated in FIG. 3 also comprises a display 3B having a flat surface 5B disposed in an object plane 7B. The catadioptric eyepiece system 1B further comprises optics 19B comprising a lens system 27B, a concave first mirror 37B and a first beam splitter 39B. The lens system 27B comprises four lenses L1B, L2B, L3B and L4B. Furthermore, the catadioptric eyepiece system 1B has an exit pupil 23B.

The optics 19B are configured to image a portion of the object plane 7B into an intermediate image 24B formed in a curved intermediate image plane 25B.

In contrast to the reflective display 3 of the embodiment illustrated in FIG. 1, the catadioptric eyepiece system 1B has a light emitting display. The light emitting display 3B may be configured to generate an image on the flat surface 5B by actively emitting light. Four exemplary rays 47B, 49B, 51B and 53B emerge from the display 3B into a beam path 21B from the display 3B to the exit pupil 23B. The rays are first incident onto a first surface 33B of the first system 27B. Note that some of the rays illustrated in FIG. 3 run above and below the paper plane of FIG. 3.

The optics 19B, in particular the lens system 27B, is configured to generate an intermediate pupil 35B upstream of the intermediate image 24B. Rays 47B and 51B parallely emerging from the object plane 7B pass the intermediate pupil 35B at a same location 52B.

Note that the lens system 27B is configured to generate the intermediate pupil 35B within the lens system 27B, in particular within the lens L4B of the lens system 27B.

Furthermore, the lens system 27B comprises a meniscus lens 55B as L3B, i. e. curvatures of two surfaces 57B of the meniscus lens 55B opposite to each other have the same sign which means that the curvature of said surfaces are directed into a same direction. In particular, the surfaces 57B of the meniscus lens 55B may be concentric to a center 59B of the intermediate pupil 35B, i. e. a point located at the intersection of an optical axis 61B of the optics 19B, in particular the lens system 27B, and the intermediate pupil 35B. That is, at least a portion of each of the surfaces 57B coincides with a surface of a virtual sphere centered at the center 59B of the intermediate pupil 35B, wherein the radius of the virtual sphere corresponds to the radii of curvature of the surfaces 57B, respectively. Simultaneously, the center 59B may be an intermediate pupil for the first mirror 37B. In this case, the meniscus lens 55B can compensate spherical aberrations of all field bundles generated by the first mirror 37B.

The first beam splitter 39B contained in a first beam splitter element 41B is configured to transmit the beam path 21B emerging from the lens system 27B to the first mirror 37B and to reflect light emerging from the first mirror 37B to the exit pupil 23B. The first mirror 37B is a front surface mirror. As the lens system 27B has positive optical power resulting in a positive Petzval curvature and the first mirror 37B, the first beam splitter 39B and the first beam splitter element 41B together have a positive optical power resulting in a negative Petzval curvature, the Petzval curvatures may compensate each other. Therefore, the Petzval curvature of the optics 19B may be reduced resulting in high quality imaging.

The catadioptric eyepiece system 1B may be configured to provide a diopter compensation by providing displaceable components of the optics 19B. In particular, the display 3B and at least one lens of the lens system 27B may be displaceable relative to each other in order to provide the diopter compensation. When the catadioptric eyepiece system 1B is set for an emmetropic eye, an infinite conjugate image of the image generated by the display 3B is formed at the exit pupil 23B, i. e. rays emerging from a same location of the object plane 7B are parallel to each other at the exit pupil 23B and rays emerging from the object plane 7B at different locations but at same inclinations relative to the object plane 7B are located at a same location in the exit pupil 23B. In particular, the rays 47B and 51B parallely emerging from the object plane 7B pass the exit pupil 23B at a same location 60B. The rays 47B and 49B emerging at different inclinations relative to the object plane 7B from a same location on the object plane 7B are parallel to each other at the exit pupil 23B.

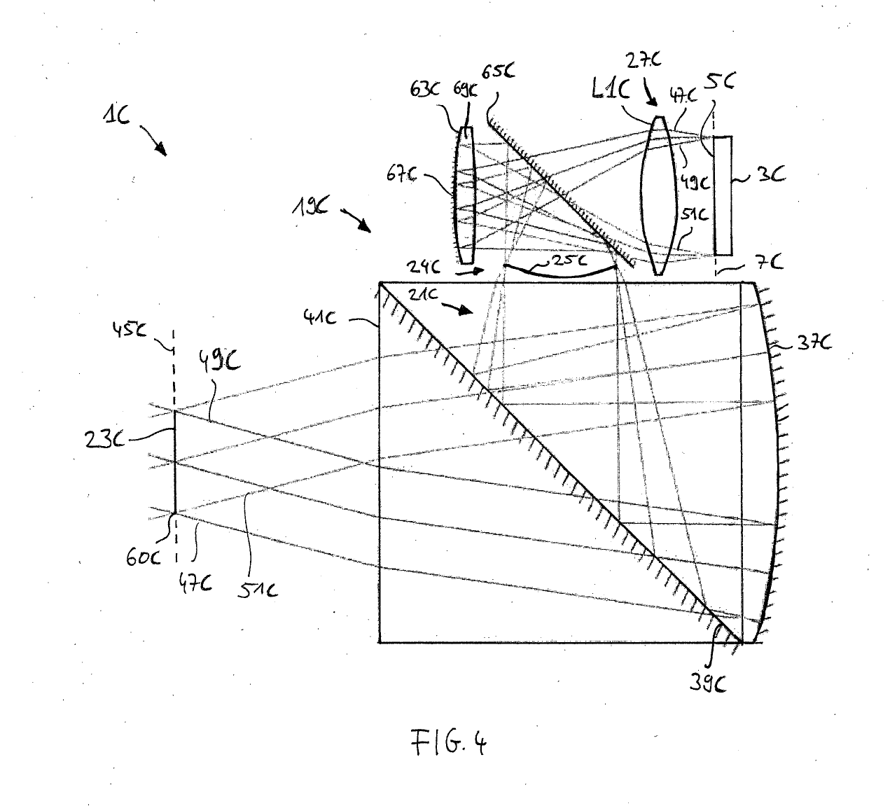

FIG. 4 shows a schematic illustration of another catadioptric eyepiece system 1C. The catadioptric eyepiece system 1C comprises a display 3C having a flat surface 5C. The flat surface is disposed in an object plane 7C. The catadioptric eyepiece system has an exit pupil 23C and comprises optics 19C providing a beam path 21C from the display 3C to the exit pupil 23C. The optics 19C, in particular a lens system 27C comprising a lens L1C together with a second mirror 67C, are configured to image a portion of the object plane 7C into an intermediate image 24C formed in a curved intermediate image plane 25C. The second mirror 63C is a back surface mirror. Therefore, the second mirror 63C comprises a refractive element 69C and a reflective surface 67C attached to a surface of the refractive element 69C opposite to a second beam splitter 65C. The back surface mirror 63C and a second beam splitter element containing the second beam splitter 65C may provide additional degrees of freedom which may be used to compensate for various aberrations. As the portion of the optics upstream of the intermediate image 24C is catadioptric system itself, the configuration of this portion may be compact, i. e. its size may be small, in particular compared to the configuration of the catadioptric eyepiece systems 1, 1B. Also, a mirror does not introduce color aberrations which additionally simplifies the optical layout.

Note that the intermediate image 24C is formed upstream of a first beam splitter element 41C containing a first beam splitter 39C.

The configuration of a first mirror 37C, the first beam splitter 39C and the first beam splitter element 41C is similar to the configuration of said components of the catadioptric eyepiece system 1. A detailed description thereof is omitted and reference is made to the description of the embodiment illustrated in FIG. 1.

The catadioptric eyepiece system 1C may also provide a diopter compensation. For example, a diopter compensation may be provided by the lens system 27C, i. e. the lens L1C of the lens system 27C, or the second mirror 63C or the display 3C being displaceable relative to each other. FIG. 4 illustrates the catadioptric eyepiece system 1C set for an emmetropic eye. Therefore, rays emerging from the object plane 7C from different locations but at same inclinations relative to the object plane 7C, e. g. rays 47C and 51C, are located in a same location 60C at the exit pupil 23C. Furthermore rays emerging from a same point of the object plane 7C but at different inclinations relative to the object plane 7C, e. g. rays 47C and 49C, are parallel to each other at the exit pupil 23C at a distance from one another. That is, an infinite conjugate image of a portion of the object plane 7C is formed at the exit pupil 23C as the optics are set for an emmetropic eye.

Note that the portion of the optics upstream of the intermediate image 24C, i. e. the lens system 27C, the second mirror 63C and the second beam splitter 65C together provide a positive optical power resulting in a positive Petzval curvature. As before, the first mirror 37C and the first beam splitter 39C together with the first beam splitter element 41C provide a positive optical power but a negative Petzval curvature. Therefore, the Petzval curvatures may compensate each other. In particular, the optical properties of said components may be selected so that the Petzval curvatures cancel each other effectively.

Detailed information on parameters of lenses and mirrors, such as thickness of the lens, material, radius of curvature as well as distances are listed in Table 3 (in units of ram).

TABLE 3

| # | Thickness/Distance | Radius | Material |
|---|---|---|---|
| 7C | — | — | |
| L1C | 5.2 | 29.728 | Air |
| | 5.0 | −23.028 | SK5 |
| 69C | 23.0 | 134.135 | Air |
| 63C | 2.5 | −55.666 | Mirror |
| 69C | −2.5 | 134.135 | SK5 |
| 65C | −12.0 | — | Mirror |
| | 12.0 | — | Air |
| 41C | 0.1 | — | Air |
| 39C | 25.0 | — | Mirror |
| | −25.0 | — | SF6 |
| | −0.1 | — | Air |
| 37C | −5.0 | 95.040 | Mirror |
| | 5.0 | — | SK5 |
| 41C | 0.1 | — | Air |
| 41C | 50.0 | — | SF6 |
| 45C | 28.0 | — | Air |

The first mirror 37C may be aspherical and be described by the aspheric constants C1=3.0850890.10⁻⁷ mm⁻³ and C2=4.844320840⁻¹¹ mm⁻⁵. The second mirror 63C, in particular its surface 67C, may be aspherical and be described by the aspheric constants C1=−2.7433401.10⁻⁶ mm⁻³ and C2=4.2089045.10⁻¹⁰ mm⁻⁵. The surface of lens L1C facing the second mirror 63C may be aspherical and be described by the aspheric constants C1=−4.660597.10⁻⁵ mm⁻³ and C2=−3.92890929.10⁻⁸ mm⁻⁵.

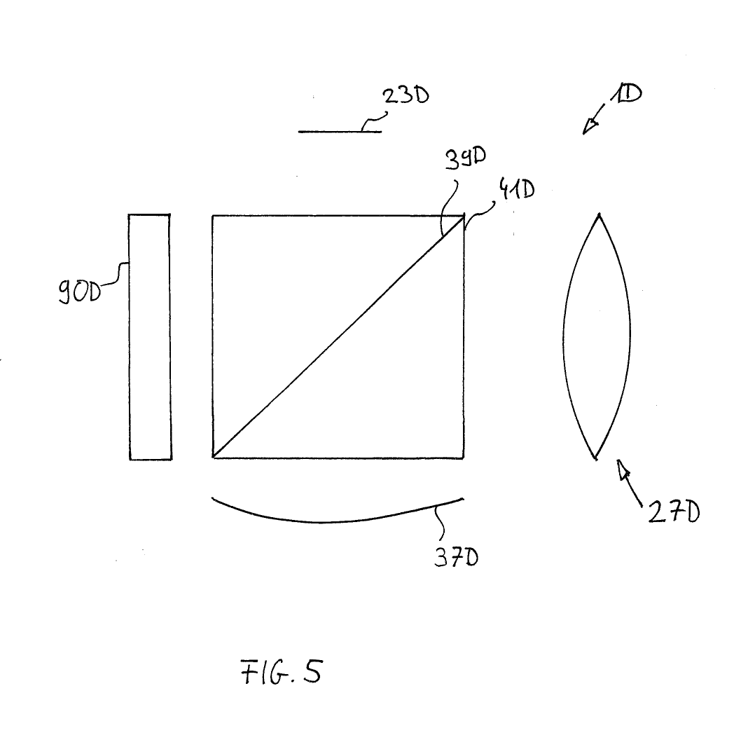

FIG. 5 shows a schematic illustration of another eyepiece system 1D. The eyepiece system 1D may be a portion of the eyepiece systems illustrated in FIGS. 1 to 4. The eyepiece system 1D comprises a lens system 27D, a first beam splitter 39D embodied by a first beam splitter element 41D and a first mirror 37D which may function as their counterparts described above.

In contrast to the embodiments of the eyepiece systems described with reference to FIGS. 1 to 4, the first beam splitter 39D is configured to direct infrared light, i e. light of wavelengths being greater than 750 nm, to an exit pupil 23D. Further an analysis apparatus 90D for analyzing a patient's eye may be provided and disposed so that (infrared) light emitted by the analysis apparatus 90D can be directed to the exit pupil 23D. The first beam splitter 39D may be configured to direct at least 80%, in particular more than 90% or more than 99%, of infrared light emitted by the analysis apparatus 90D to the exit pupil 23D.

In particular, as illustrated in FIG. 5, with respect to the first beam splitter 39D, the analysis apparatus 90D is disposed opposite to the lens system 27D, whereas the first mirror 37D is disposed opposite to the exit pupil 23D. The first beam splitter 39D is configured to reflect nearly all infrared light emitted by the analysis apparatus 90D and, hence, does not transmit infrared light. Accordingly, infrared light emitted by the analysis apparatus 90D does not enter the lens system but is fully directed towards the exit pupil 23D. Accordingly, the first beam splitter 39D may have a reflectance of at least 70%, in particular at least 90% or at least 99%, for infrared light.

Alternatively, the analysis apparatus 90D and the first mirror 37D may be interchanged in position and the first beam splitter 39D may be configured to transmit infrared light and to not reflect infrared light. Thus, again, nearly all infrared light emitted by the analysis apparatus 90D is directed to the exit pupil 23D. Accordingly, the first beam splitter may have a transmittance of at least 70%, in particular at least 90% or at least 99%, for infrared light.

Consequently, while providing the function of the eyepiece system as described above, the patient's eye may be analyzed by the analysis apparatus 90D using infrared light without interfering with the function of the eyepiece system. The analysis apparatus may comprise different monitoring systems to monitor the eye of the observer, e. g. a gaze tracker or an objective accommodation measurement device which measures the accommodation of observer's eye.

Alternatively to the embodiment described with reference to FIG. 5, a beam splitter different from the first beam splitter may be disposed in the beam path provided by the eyepiece system for introducing infrared light of an analysis apparatus into the beam path and to direct the infrared light towards a patient's eye. For example, the additional beam splitter may be disposed in the beam path between the first beam splitter and the exit pupil.

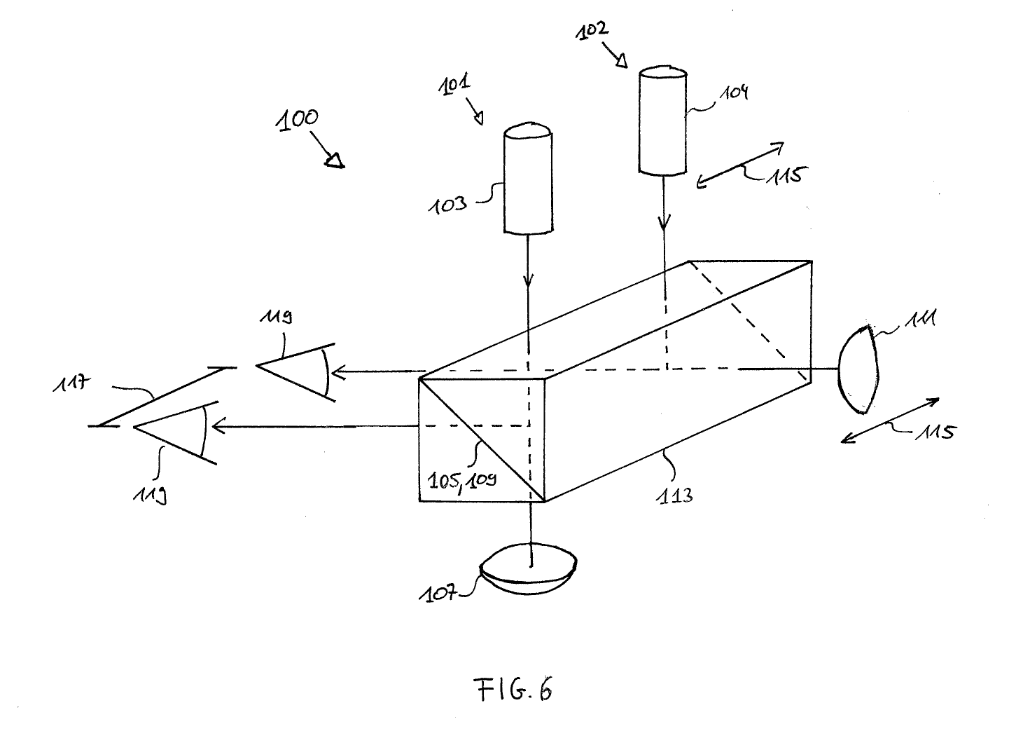

FIG. 6 shows a schematic illustration of an eyepiece system 100. The eyepiece system 100 comprises two catadioptric eyepiece systems 101 and 102. In particular, each of the catadioptric eyepiece systems 101 and 102 is one of the catadioptric eyepiece systems described above. The catadioptric eyepiece system 101 comprises a portion 103 upstream of its first beam splitter 105, its first beam splitter 105 and its concave first mirror 107. Similarly, the catadioptric eyepiece system 102 comprises a portion 104 of optics upstream of its first beam splitter 109, its first beam splitter 109 and its concave first mirror 111. Both the first beam splitter 105 of the catadioptric eyepiece system 101 and the first beam splitter 109 of the catadioptric eyepiece system 102 are portions of a single beam splitter 113.

In the eyepiece system 100, the catadioptric eyepiece system 102 is displaceable relative to the catadioptric eyepiece system 101 as indicated by arrows 115. In particular, the portions 103 and 104 each comprising a lens system, the first mirror 107 and 111 and exit pupils of the catadioptric eyepiece systems 101 and 102 may be displaceable relative to each other in a direction parallel to a long side of the single beam splitter 113. Therefore, the eyepiece 100 may be adapted to an interpupilar distance 117 between an observer's eyes 119. The first mirrors 111 and 115 are disposed on different sides of the singe beam splitter 113. Therefore, the first mirrors do not obstruct each other when displaced along the long side.

While the disclosure has been described with respect to certain exemplary embodiments thereof, it is evident that many alternatives, modifications and variations will be apparent to those skilled in the art. Accordingly, the exemplary embodiments of the disclosure set forth herein are intended to be illustrative and not limiting in any way. Various changes may be made without departing from the spirit and scope of the present disclosure as defined in the following claims.

1. A catadioptric eyepiece system having an exit pupil, comprising:
a display having a surface disposed in an object plane;
optics providing a beam path from the display to the exit pupil and being configured to image a portion of the object plane into an intermediate image formed in a curved intermediate image plane;
wherein the optics comprise:
a lens system of positive optical power comprising at least one lens, wherein the lens system is disposed in the beam path downstream of the display and upstream of the intermediate image;
a concave first mirror disposed in the beam path downstream of the intermediate image and upstream of the exit pupil; and
a first beam splitter disposed in the beam path between the lens system and the first mirror and between the first mirror and the exit pupil.

2. The catadioptric eyepiece system according to claim 1, wherein a focal plane of the first mirror coincides with the curved intermediate image plane if the optics are set for an emmetropic eye.

3. The catadioptric eyepiece system according to claim 1, wherein the curved intermediate image plane has a radius of curvature less than 200 mm, in particular less than 80 mm, more in particular less than 20 mm.

4. The catadioptric eyepiece system according to claim 1, wherein the intermediate image is a real image.

5. The catadioptric eyepiece system according to claim 1, wherein the first mirror has a radius of curvature less than 180 mm, in particular less than 90 mm, more in particular less than 50 mm.

6. The catadioptric eyepiece system according to claim 1, wherein at least a portion of the intermediate image is formed within a first beam splitter element containing the first beam splitter.

7. The catadioptric eyepiece system according to claim 1, wherein at least one of the display and the at least one lens are displaceable relative to each other along an optical axis for diopter compensation.

8. The catadioptric eyepiece system according to claim 1, wherein the first mirror and the first beam splitter are configured to generate an eye relief being greater than 10 mm, in particular greater than 20 mm, more particular greater than 30 mm.

9. The catadioptric eyepiece system according to claim 1, wherein the first mirror is one of a front surface mirror, a back surface mirror and a mirror sharing a common surface with a first beam splitter element containing the first beam splitter, wherein the common surface is disposed in the beam path.

10. The catadioptric eyepiece system according to claim 1, wherein the first beam splitter is configured to direct rays of the beam path emerging from the intermediate image to the first mirror and to direct rays emerging from the first mirror to the exit pupil.

11. The catadioptric eyepiece system according to claim 1, wherein the lens system and the first mirror are configured to compensate for each other's Petzval curvature.

12. The catadioptric eyepiece system according to claim 11, wherein the lens system and the first mirror are configured so that an absolute value of a Petzval radius of curvature of the catadioptric eyepiece system is greater than 150 mm, in particular greater than 200 mm, more in particular greater than 250 mm.

13. The catadioptric eyepiece system according to claim 1, wherein the optics further comprise a second mirror disposed in the beam path downstream of the lens system and upstream of the intermediate image.

14. The catadioptric eyepiece system according to claim 13, wherein the optics further comprise a second beam splitter disposed in the beam path between the lens system and the second mirror.

15. The catadioptric eyepiece system according to claim 1, wherein the optics are further configured to form an intermediate pupil in the beam path upstream of the intermediate image.

16. The catadioptric eyepiece system according to claim 1, wherein the at least one lens comprises at least one of a cemented lens element, a lens having an aspheric surface and a meniscus lens, wherein at least one surface of the meniscus lens is concentric to a center of the intermediate pupil.

17. The catadioptric eyepiece system according to claim 1, wherein the optics are further configured to form the intermediate pupil outside of the lens system.

18. The catadioptric eyepiece system according to claim 1, further comprising:
a light source configured to emit illumination light;
a third beam splitter disposed in a beam path between the light source and the display, wherein the third beam splitter is configured to direct the illumination light onto the flat surface and to direct light reflected by the display into the beam path of the optics;
wherein the display is a reflective display, in particular one of a liquid crystal on silicon display and a digital micromirror device.

19. The catadioptric eyepiece system according to claim 18, wherein a working distance between the object plane and a first surface of the optics is greater than 30 mm, in particular greater than 35 mm, more in particular greater than 40 mm.

20. The catadioptric eyepiece system according to claim 1, wherein the display is a light emitting display.

21. The catadioptric eyepiece system according to claim 1, wherein the exit pupil has a diameter being greater than 5 mm, in particular greater than 9 mm, more in particular greater than 14 mm.

22. The catadioptric eyepiece system according to claim 1, further comprising an aperture stop disposed in the beam path between the first beam splitter and the display.

23. The catadioptric eyepiece system according to claim 1, further comprising a polarizer disposed upstream of the first beam splitter and a waveplate disposed between the first beam splitter and the first mirror and wherein transmission and reflection of the first beam splitter are polarization dependent.

24. The catadioptric eyepiece system according to claim 1, wherein the first beam splitter is configured to direct infrared light emitted by an analysis apparatus for analyzing a patient's eye to the exit pupil.

25. An eyepiece system comprising at least two catadioptric eyepiece systems according to claim 1, wherein the first beam splitters of the at least two catadioptric eyepiece systems are portions of a single beam splitter.

26. The eyepiece system according to claim 25, wherein the lens system, the first mirror and the exit pupil of the at least two catadioptric eyepiece systems are displaceable relative to each other in a direction parallel to a long side of the single beam splitter.

27. The eyepiece system according to claim 25, wherein the first mirrors of the at least two catadioptric eyepiece systems are located on different sides of the single beam splitter.

28. An optical system having an eyepiece system according to claim 1, wherein the optical system comprises at least one of an optical microscope, a surgical microscope, a viewfinder, a charged particle beam microscope and a head-mounted display.
